(19) United States
(12) Patent Application Publication
(10) Pub. No.: US 2025/0040544 A1
(43) Pub. Date: Feb. 6, 2025

(54) ENCAPSULATED PHEROMONE FORMULATIONS RESISTANT TO LIGHT RADIATION

(71) Applicant: MELCHIOR MATERIAL AND LIFE SCIENCE FRANCE, LACQ (FR)

(72) Inventors: Olivier GUERRET, PERN (FR); Audrey MIRASSOU, Casteide Candau (FR); Sylvain BOURRIGAUD, Morlanne (FR)

(73) Assignee: MELCHIOR MATERIAL AND LIFE SCIENCE FRANCE, LACQ (FR)

(21) Appl. No.: 18/847,134

(22) PCT Filed: Mar. 16, 2023
(86) PCT No.: PCT/FR2023/050371

§ 371 Date: Sep. 13, 2024

(30) Foreign Application Priority Data
Mar. 16, 2022 (FR) FR2202288
Sep. 19, 2022 (FR) FR2209455

(51) Int. Cl. A01N 37/06; A01N 25/28; A01N 27/00; A01N 31/02; A01N 35/04; A01P 21/00

(52) U.S. Cl. CPC A01N 37/06; A01N 25/28; A01N 27/00; A01N 31/02; A01N 35/04; A01P 21/00

(57) ABSTRACT

The present invention relates to pheromone microcapsules having a median diameter D50 ranging from 0.5 μm to 20 μm and comprising carbon black particles, as well as to a process for the production thereof and to the use thereof in the protection of crops exposed to sunlight or artificial light.

### FIELD OF THE INVENTION

The present invention relates to encapsulated pheromone formulations that are resistant to light radiation. More particularly, it relates to pheromone microcapsules comprising carbon black particles, as well as the method for manufacturing same and their use in protecting plants and crops from pests, such as insects or mammals, in particular in the case of exposure to light.

### PRIOR ART

The encapsulation of pheromones is a method of choice for delivering these active ingredients in cultivations, parks, gardens or forests, in particular for pheromones used to attract pests or to disturb their reproduction by a sexual confusion mechanism. Pheromones vectorised in this way can equally be insect pheromones or mammal pheromones.

The natural function of a pheromone is to transport information from one individual of a species to other individuals, in order to provoke a specific reaction. These pheromones are molecules or very precise mixtures of molecules in terms of stereochemistry and in terms of the ratio of constituents. In the world of phytosanitary products, their action in the fields must last for periods ranging from 4 weeks to 6 months. Although encapsulation can slow diffusion by evaporation of the pheromone, it does not guarantee the period of efficacy of the product unless the stability of the active ingredients in the capsules, before their evaporation, is considered. Several examples of pheromones can illustrate this remark, according to the animal families concerned. Thus, Table 1 below illustrates the pheromones of certain lepidopterae containing conjugated unsaturated compounds.

TABLE 1

| Insect | |
|---|---|
| (lepidoptera) | Main component of the pheromone |
| Lobesia | 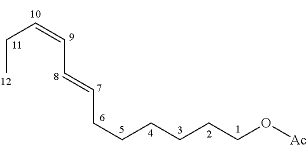 [SMILES: CC/C=C\C=C\CCCCCCOC(C)=O] (I) |
| Codling moth | 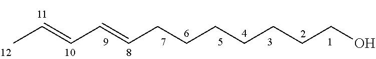 (II) |
| Tomato leaf miner | 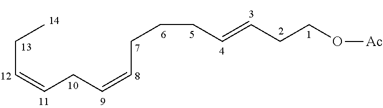 [SMILES: CC/C=C\C/C=C\CCC/C=C/CCOC(C)=O] (III) |
| Horse-chestnut leaf miner | 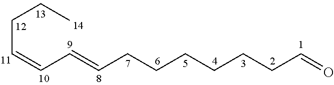 (IV) |
| Pine processionary | 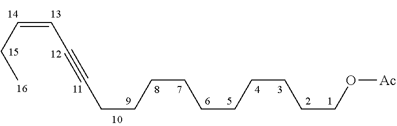 [SMILES: CC/C=C\C#CCCCCCCCCCCOC(C)=O] (V) |
| Amyelois transitella (Navel orangeworm) | 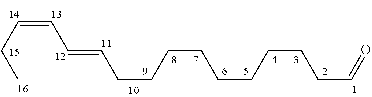 [SMILES: CC/C=C\C=C\CCCCCCCCCC=O] (VI) |
| Grapholita molesta | 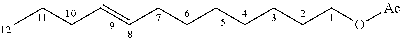 [SMILES: CCC/C=C/CCCCCCCOC(C)=O] (VIII) |
| | 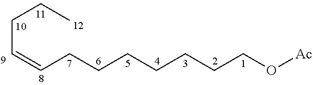 [SMILES: CCC/C=C\CCCCCCCOC(C)=O] |
| Ectomyelois ceratoniae (Carob moth) | 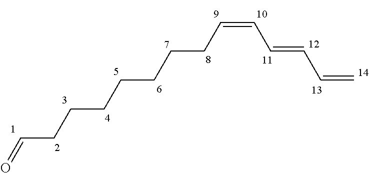 (X) |
| Thaumetopoea processionea (Oak processionary) | 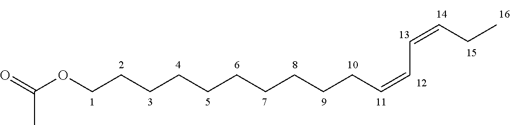 [SMILES: CC/C=C\C=C/CCCCCCCCCCOC(C)=O] (XI) |

Similarly, the alarm pheromone for a large number of aphids is β-farnesene with the following structure (VII):

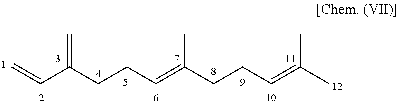

This pheromone is also an attractant for aphid predators and can be used for this property in order to protect cultivations. It is sensitive to light (visible or UV) and any change in geometry or functionality alters the use of the molecule as a vector of information for the insects (both for the aphid and for its predators).

The following compound of structure (XII) is an analogue of the main sex pheromone of the Carob moth:

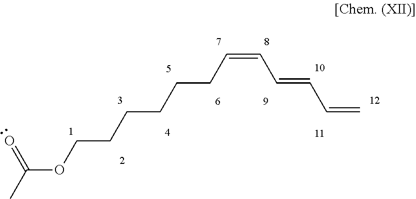 [SMILES: C=C/C=C/C=C\CCCCCCOC(C)=O]

All the compounds (I) to (VI) and (VIII) to (XI) are themselves major compounds of the sex pheromones of the females of the species. A change in one structural parameter of these molecules renders them ineffective. In particular, the isomerisations of cis double bonds switches off the activity of these compounds. These isomerisations can be caused by free radicals, but also by interactions with variable wavelength photons.

Many academic studies have studied the phenomena leading to isomerisation of these compounds in storage (absence of light) and in the field (exposure to daylight and to the air). Thus, Brown et al. (Economic Entomology, vol. 79, n°4, 1986, page 923) studied elastomer-based formulations impregnated with pheromones (I) and (II) enabling the impact of light on these pheromones to be limited. They show, like other following works (see J. Vrkoc et al. J. of Chem. Ecology, 4, 5, 1988, page 1347), that the choice of material is essential for good pheromone stability during storage and during use in the field, red elastomers having a less good performance than black elastomers which themselves a have less good performance then grey elastomers. According to these authors, the factor most promoting the isomerisation of pheromones is firstly the type of vulcanisation used for manufacturing the elastomers: vulcanisation with sulfur, generating disulfides, induces a very high rate of isomerisation, while vulcanisation with phenolic resins, cross-linked urethanes or peroxides does not induce isomerisation. Since pheromones are often a very expensive component of phytosanitary formulations for sexual confusion or other techniques for combating pests, its stability during use should be optimised in order to optimise the effectiveness which lies in its diffusion in the air.

When it comes to stabilising these pheromones based on compounds comprising photosensitive conjugated unsaturated systems, a person skilled in the art would make use of chemical stabilisers.

For example, in U.S. Pat. No. 5,364,969, the authors describe the use of a phenolic antioxidant (such as butylated hydroxytoluene or BHT) in combination with an anti-UV additive: Tinuvin® 536 from the family of benzotriazoles. In U.S. Pat. No. 6,252,106, the benzotriazole-type ant-UV compound Tinuvin® P is used, at levels between 0.1% and 10% by weight relative to the weight of the pheromone.

In WO2002/080672, the authors mix the pheromones with di-tert-butyl-2,2′-methylenedi-p-cresol (MBMBP) as anti-oxidant and this mixture is used with any type of pheromone diffuser, such as microcapsules (e.g. urea-, gelatin-, or liposome-based microcapsules), microbeads, laminated plastic straws and larger mechanical devices such as hollow fibres or links to be twisted. The authors indicate that this antioxidant can be combined with UV protectants such as carbon black or titanium dioxide but there is no particular example allowing this possibility to be corroborated, even less so in the context of the use of microcapsules. Indeed, since these mineral fillers have particle sizes on the order of a micrometre, their insertion in microcapsules of a similar size would not appear obvious. At best, the simultaneous presence of pheromone microcapsules and carbon black or the use of other larger diffusion systems can be envisaged. However, the superposition of two populations of microcapsules, one containing the pheromone and the other containing carbon black, cannot give the same stabilising and protective effect as a single population of microcapsules containing, in its core, both the light-sensitive active ingredient (pheromone) and its protective filler (carbon black).

In WO2017/050956A1 and WO2016/131883A1, the applicant has described a particular method for encapsulation of pheromones having the particular feature of not requiring chemical reactions in order to construct the microcapsules which organise themselves under the action of attractive and repulsive forces of the fat and water components controlled by an HASE additive (Hydrophobic Alkali Swellable Emulsion). In these applications, the pheromone stabilisers are chemical molecules that are soluble with the pheromone and remain at the core of the microcapsules. The stabiliser molecules are ter-butyl hydroquinone, propyl gallate, t-butyl-hydroxy anisole, p-methyl-hydroxy-benzoate, N, N-diethyl-toluamide, BHT, alpha-thioglycerine, nitroxides and alkoxyamines. These chemicals are known antioxidants and UV protectants. The sizes of the particles obtained are of order 0.1 to 10 μm, so that it is difficult to introduce carbon blacks which have similar dimensions.

Thus, the current prior art does not discuss introducing carbon black into microcapsules containing pheromones which could however solve the problem of the photosensitivity of pheromones in the microcapsules used as diffusers.

Carbon blacks are chemicals produced industrially using various processes, such as those described in patent U.S. Pat. No. 9,574,087. These powders are in the form of grouped primary particles, agglomerated in a cluster. The size of the primary particles can be of order several tens of nanometres, while the agglomerates have sizes on the order of a micrometre. The properties conferred by carbon blacks to materials in which they are dispersed are always linked to the state of dispersion of the carbon black in this material. The usual applications for carbon blacks are in the field of plastics (for example, pipes), elastomers (for example vehicle wheels), inks, varnishes and paints. In addition to mechanical properties, carbon blacks provide significant electromagnetic properties (conductivity, absorption of radiation over a wide spectrum, for example). The problem of the dispersion of carbon blacks is specific to each type of use, because carbon blacks are both very hydrophobic and very poorly dispersible in not very polar organic media.

The applicant has not found any example in the prior art which combines carbon blacks and pheromones effectively, and in particular in microencapsulated pheromone formulations comprising, in their core, both the pheromone and carbon black.

However, when it comes to stabilising the stereochemistry of pheromone comprising conjugated systems, such as the compounds of pheromones (I) to (IX), the chemical antioxidants or the UV protectants are not sufficient to maintain good isomerism when the pheromone diffusers are exposed to sunlight, and the use of carbon blacks could contribute an economic and effective solution to this problem.

An entirely illustrative case is that of compound (VI) for which the commercial products must include opaque containers for preserving the molecule for several months in the fields. Examples include aerosol bombs with trademarks Semios or Suterra (cf. J. Beck, Journal of Agricultural and Food Chemistry, 2012, 60, 8090).

Another product from Suterra, Check Mate F Now (registration number EPA: 56336-38), is in the form of a microcapsule of pheromone suspension in water containing 1.16% of compound (VI). This product covers a cultivation for only 30 days which is less than the theoretical duration of evaporation of the compound resulting in a loss of active ingredient by chemical degradation.

There is therefore still a need to provide novel microcapsule formulations of light-sensitive pheromones, making it possible to protect these pheromones from the harmful effects of light and extend the effectiveness of these formulations over time. It is also important that such microcapsule formulations remain usable in conventional spraying equipment used by farmers.

### SUMMARY OF THE INVENTION

An object of the present invention is microcapsules having a median diameter D50 ranging from 0.5 μm to 20 μm, preferably from 1 μm to 10 μm, containing a pheromone and carbon black particles.

The use of microcapsules having a median diameter D50 ranging from 0.5 μm to 20μ m enables, in particular, their application by spraying; higher diameters risk blocking the nozzles of spraying equipment conventionally used by farmers, thus preventing an effective treatment of cultivated fields.

The microcapsules according to the invention preferably comprise:
a core comprising a mixture of wax, oil, pheromone (for example insect or mammal pheromone), carbon black particles, preferably with primary particles having a median diameter D50 ranging from 10 nm to 50 nm, the core further comprising one or more additives, preferably chosen from a, preferably non-ionic, carbon black particle dispersing additive, an anti-UV additive, an antioxidant and a mixture thereof, and
a solid outer shell surrounding the core, the shell comprising, more particularly, an HASE polymer, optionally totally or partially neutralised, in the form of a sodium, potassium or ammonium salt.

The carbon black particles preferably consist of primary particles having a median diameter D50 ranging from 10 nm to 50 nm, notably from 10 nm to 40 nm, for example from 11 nm to 30 nm, in particular from 12 nm to 20 nm.

The presence of carbon black particles in the microcapsules protects the pheromone also present in these microcapsules against light radiation and prevents its degradation and/or its isomerisation in the presence of light. All of the pheromone is thus preserved for the period of exposure to light, making it possible to have a longer effectiveness.

However, if the carbon black primary particles have a diameter much smaller than the size of these microcapsules, such as a median diameter D50 of 10 nm to 50 nm, these primary particles agglomerate together and are therefore in the form of agglomerates having a diameter on the order of a micrometre or larger, not allowing an effective encapsulation of the carbon black in microcapsules having a diameter of the same order of magnitude.

More specifically, it surprisingly appears the HASE polymer used for preparing the shell of the microcapsules can also, during the manufacturing method of the microcapsules, disperse the carbon black agglomerates such that the primary carbon black particles no longer agglomerated together and can thus be incorporated in microcapsules having a median diameter D50 of 0.5 μm to 20 μm. Indeed, it appears that the particular nature of the HASE polymer which combines both ionic functions and highly hydrophobic functions makes it possible to disperse the carbon black agglomerates due to the strong affinity of these two types of functionalities with carbon black. Thus, it is possible to both disperse the carbon black agglomerates and to incorporate them, with the pheromone, in microcapsules having a median diameter D50 from 0.5 μm to 20 μm.

Another object of the present invention is likewise the use of the microcapsules according to the invention in order to protect a plant (in particular a cultivation) or a crop against insects or mammals, in particular when said plant or crop is exposed to light (e.g. solar or artificial light).

The present invention likewise concerns a method for manufacturing microcapsules according to the invention. This method comprises mixing ingredients forming the core of the microcapsules, namely, in particular, wax, oil, pheromone (for example insect or mammal pheromone), carbon black particles, optional additive(s), forming cores the of the of the microcapsules from this mixture, and their coating with the material constituting the outer shell, preferably an HASE copolymer. This method can implement any microcapsule forming technique, in other words the depositing of a shell around a core, known in the art.

When the outer shell comprises a HASE copolymer, said method advantageously comprises:
(A) preparing a fatty phase comprising the wax, the oil, the pheromone (for example insect or mammal pheromone) and the carbon black particles, and optionally one or more additives when they are present, the fatty phase having a temperature greater than the melting temperature of the wax,
(b) preparing an aqueous solution comprising the HASE copolymer, the aqueous solution having a pH greater than or equal to 7.6, notably greater than or equal to 8, in particular 8 to 10, and a temperature substantially identical to that of the fatty phase,
(c) adding the fatty phase to the aqueous solution comprising the HASE copolymer, and stirring so as to form a dispersion of fatty phase droplets in the aqueous solution, and
(d) acidifying to a pH of 6 to 7.5, preferably from 6.5 to 7.2.

### DETAILED DESCRIPTION OF THE INVENTION

The object of the present invention is therefore that of providing microcapsules containing both pheromone-type active ingredients and carbon black particle-type fillers which stabilise these active ingredients when they are exposed to light, typically during use in the field, increasing the duration of effectiveness of these active ingredients.

### Microcapsules

The microcapsules according to the invention have a median diameter D50 ranging from 0.5 μm to 20 μm, preferably from 1 μm to 10 μm, and comprising a core containing the pheromone-type active ingredient or ingredients and the carbon black particle type fillers, this core being surrounded by a solid outer shell.

Within the meaning of the present invention, “median diameter D50” of microcapsules shall mean the median diameter of a distribution of microcapsules, i.e. the diameter such that 50% of the microcapsules by volume have a diameter less than equal to the value, and 50% of the microcapsules by volume have a diameter greater than this value. It is measured by laser diffraction, in particular using a Mastersizer 3000 instrument, in particular according to the method described in the experimental part.

The size distribution of microcapsules will be more particularly monomodal.

Within the meaning of the present invention, the term “monomodal” shall mean that the size distribution curve of microcapsules has a single peak. The size distribution curve represents the percentage by volume of microcapsules as a function of their diameter and is determined by laser diffraction, in particular using a Mastersizer 3000 instrument, in particular according to the method described in experimental part.

Within the meaning of the present invention, “pheromone” shall mean a chemical substance or a mixture of chemical substances emitted by an animal, or an analogue of such a chemical substance or of such a mixture of chemical substances, and which represents a stimulus for the individuals of this animal species. Such molecules can also stimulate individuals from other species, such as, for example, the territorial pheromone of a predator such as a fox, which can be perceived as a danger message by rodent species. The pheromones can be produced either by living organisms or by chemical synthesis. The pheromone is more particularly a chemical substance or a mixture of chemical substances emitted by an animal.

The pheromones used in the context of the present invention preferably carry a photosensitive function, such as one or more unsaturations, preferably conjugated unsaturations.

Within the meaning of the present invention, “unsaturation” shall mean a C═C double bond or a C≡C triple bond.

Within the meaning of the present invention, “conjugated unsaturations” shall mean an unsaturation as defined above and bonded to another unsaturation as defined above by a single bond.

More particularly, the pheromone will be an insect or mammal pheromone, or optionally an analogue thereof, such as a lepidoptera pheromone (such as a lepidoptera of the genus Lobesia, codling moth, tomato leaf miner (Tuta absoluta), horse-chestnut leaf miner, pine processionary, Amyelois transitella), Grapholita molesta, carob moth or oak processionary), or an aphid pheromone, or optionally an analogue of these, or a mixture thereof.

The pheromone can be an unsaturated long-chain lepidoptera pheromone, a terpene such as one of the molecules (I) to (VI), (VIII), (IX) and (X) to (XII) above, a sesquiterpene such as molecule (VII) above, or a mixture thereof.

The pheromone can more particularly be chosen from molecules (I) to (XII) above and the mixtures thereof, in particular from molecules (I) to (IX) above and the mixtures thereof.

The carbon black particles consist of primary particles which can agglomerate together in order to form agglomerates. Preferably, the primary particles are not agglomerated, or are weakly agglomerated, in the microcapsules according to the invention. They are therefore preferably dispersed in the microcapsules.

Preferably, the primary particles of the carbon black particles used in the context of the present invention have a median diameter D50 ranging from 10 nm to 50 nm, particularly from 10 nm to 40 nm, for example from 11 nm to 30 nm, in particular 12 nm to 20 nm.

Within the meaning of the present invention, “median diameter D50” of the primary carbon black particles shall mean the median diameter of a distribution of primary carbon black particles, i.e. the diameter such that 50% of the particles by volume have a diameter less than or equal to this value and 50% of the particles by volume have a diameter greater than this value. It is measured by electron microscopy, notably as described in E. A. Grulke, S. B. Rice, J. Xiong, K. Yamamoto, T. H. Yoon, K. Thomson, M. Saffaripour, G. Smallwood, J. W. Lambert, A. J. Stromberg, R. Macy, N. Briot, D. Qian, Size and shape distributions of carbon black aggregates by transmission electron microscopy, Carbon (2018).

The carbon black particles can be synthetic, in particular obtained from acetylene, or can be obtained by grinding carbon. The carbon black is preferably synthetic, enabling primary particles of smaller sizes to be obtained.

The preferred carbon black particles are carbon black particles intended for applications in inks and surface coatings, such as grades 430, 700, 800, 1100 and 1300 of the brand Monarch® or grades 1200, 1600 and 1800 of the brand Emperor® from Cabot or the grades of the brands Special Black, Printex®, Arosperse® and NIPex® from Orion Specialty Carbon Blacks.

The microcapsules according to the invention preferably comprise a core containing the one or more pheromone-type active ingredients and the carbon black particle-type fillers, this core being surrounded by a solid outer shell.

### Core of the Microcapsules

The core of the microcapsules advantageously represents 90% to 99.9% by weight of the weight of the microcapsules.

The core comprises a pheromone mixture (for example, insect and mammal pheromones) and carbon black particles, and advantageously a wax and an oil.

The core preferably comprises, notably consists of, a mixture of wax, oil, pheromone (for example insect or mammal pheromone), carbon black particles and one or more additives, preferably chosen from a carbon black particle dispersing additive, preferably non-ionic, an anti-UV additive, an antioxidant and a mixture thereof. The core preferably comprises a dispersant additive, preferably non-ionic.

The core advantageously contains, relative to the weight of the core:
0.5% to 30%, notably 0.5% to 20%, in particular 1% to 15%, preferably 1% to 10%, by weight of pheromone (for example insect or mammal pheromone),
0.01% to 10%, preferably 0.1% to 5%, by weight, carbon black particles,
0.5% to 50%, notably 0.5% to 30%, in particular 1% to 25%, preferably 1 to 20%, by weight wax, and
20 to 95%, notably 30 to 90%, preferably 40 to 80%, by weight oil.

The core preferably contains, relative to the weight of the core:
0.5% to 30%, notably 0.5% to 20%, in particular 1% to 15%, preferably 1% to 10%, by weight of pheromone (for example insect or mammal pheromone),
0.01% to 10%, preferably 0.1% to 5%, by weight, carbon black particles,
0.5% to 50%, notably 0.5% to 30%, in particular 1% to 25%, preferably 1% to 20%, by weight wax,
20% to 95%, notably 0.5% to 90%, preferably 40% to 80%, by weight, oil, and
up to 10% (e.g. 0.01% to 10%), notably up to 5%, preferably from 0.1% to 5%, by weight of a, preferably non-ionic, carbon black particle dispersing additive, relative to the weight of the core.

Preferably, the preferably non-ionic, carbon black particle dispersing additive is present in the core in an amount by weight less than or equal to that of the carbon black particles.

In particular, the core may contain up to 10% (e.g. 0.01% to 10%), notably up to 5%, preferably from 0.1% to 5%, of one or more additives.

Within the meaning of the present invention, “wax” shall mean a lipophilic compound that is solid at ambient temperature (approximately 25° C.) and atmospheric pressure (1013.25 hPa), preferably of natural origin. The wax preferably has a melting temperature greater than 45° C. at atmospheric pressure.

Waxes that can be used in a composition according to the invention can be chosen from waxes of animal origin, waxes of plant origin, mineral waxes, synthetic waxes and the mixtures thereof. Waxes of animal origin include beeswax, lanolin wax or Chinese wax. Waxes of plant origin can include rice wax, carnauba wax, candelilla wax, jojoba wax, ouricury wax, alfa wax, cork fibre wax, sugar cane wax, Japan wax or sumac wax. Mineral waxes may include montan wax, microcrystalline waxes, paraffins or ozokerite. Synthetic waxes may include polyethylene waxes, waxes obtained by Fisher-Tropsch synthesis or waxy copolymers and the esters thereof. Hydrogenated derivatives of waxes cited above can also be used as wax within the context of the present invention Also included are waxes obtained by catalytic hydrogenation of oils of animal or vegetable origin having C8-C32, linear or branched, unsaturated fatty chains. These include, in particular, hydrogenated jojoba oil, hydrogenated sunflower oil, hydrogenated castor oil, hydrogenated coconut oil or hydrogenated lanolin oil, as well as di-(trimethylol-1,1,1-propane) tetrastearate. It is also possible to use waxes obtained by transesterification and hydrogenation of oils of vegetable origin, such as castor or olive oil, such as the waxes sold under the names Phytowax ricin 16L64®, Phytowax ricin 22L73® and Phytowax Olive 18L57® by SOPHIM.

Advantageously, the wax is chosen from the group consisting of beeswax, lanolin wax, Chinese wax, rice wax, carnauba wax, candelilla wax, jojoba wax, ouricury wax, alfa wax, cork fibre wax, sugar cane wax, Japan wax, sumac wax, montan wax, microcrystalline waxes and the mixtures thereof.

Within the meaning of the present invention, “oil” shall mean a fatty compound that is liquid at ambient temperature and atmospheric pressure, immiscible with water and non-volatile.

The oil according to the invention may be chosen from oils of vegetable origin, oils of animal origin, synthetic oils and the mixtures thereof; preferably chosen from oils of vegetable origin, oils of animal origin and the mixtures thereof. The oil of vegetable origin will advantageously be chosen from the group consisting of sunflower oil, peanut oil, soybean oil, rapeseed oil, corn oil, olive oil, grape oil, walnut oil, flaxseed oil, palm oil, coconut oil, argan oil, avocado oil, almond oil, hazelnut oil, pistachio oil, rice oil, cottonseed oil, wheat germ oil, sesame oil and the mixtures thereof. The oil of animal origin will advantageously be chosen from the group consisting of cod liver oil, shark oil and the mixtures thereof.

One or more additives may also be present in the core of the microcapsules, preferably chosen from a, preferably non-ionic, carbon black particle dispersing additive, an anti-UV additive, an antioxidant and a mixture thereof.

The preferably non-ionic, carbon black particle dispersing additive can be Disperbyk® 163 from Byk Chemie or can be Borchi® Gen 0451 from Borchers. Such dispersants can be prepared according to EP2091984 or EP2125909, the teaching of which is incorporated by reference, concerning the compositions and copolymers that can be used as dispersant agent.

Anti-UV additives or antioxidants that are well-known to a person skilled in the art can be added in order to limit the oxidation reactions caused by the oxygen at the surface of the particles, such as tert-butylhydroxytoluene (BHT), tert-butylhydroxyanisole (BHA), tocopherol, oxybenzone, octabenzone, the derivatives of the family of benzotriazoles (such as 2-(2′-hydroxy-3′,5′-tertamylphenyl)benzotriazole, or 2-(2′-hydroxy-3′-tert-butyl-5′-methyl-phenyl)-5-chlorobenzotriazole), propyl gallate, or the derivatives of 4-tetramethyl-piperidine, notably known under the name HALS (“hindered amine light stabilizers”) and described in Schaller, C., Rogez, D. & Braig, A. “Hindered amine light stabilizers in pigmented coatings.” J Coat Technol Res 6, 81-88 (2009), and its nitroxides (obtained by oxidation of HALS as indicated in FR2788272).

### Shell of the Microcapsules

The shell advantageously comprises an HASE copolymer, optionally totally or partially neutralised, in the form of a sodium, potassium or ammonium salt.

Within the meaning of the present invention, “HASE copolymer” (HASE being the abbreviation of “Hydrophobically modified Alkali Swellable Emulsion”), shall mean a copolymer of (meth)acrylic acid (e.g. methacrylic acid), alkyl acrylate, (e.g. ethyl acrylate) and one on more hydrophobic macromonomers of following chemical formula A:

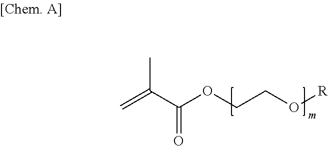

wherein:
m is an integer greater than or equal to 5, preferably between 10 and 30, and
R is a hydrocarbon group of formula CₙH₂ₙ₊₁, wherein n is an integer between 9 and 25, preferably between 10 and 22 and more preferably equal to 12, 16 or 22. The group R is therefore hydrophobic.

Within the meaning of the present invention, “totally or partially neutralised” shall mean that all or part of the carboxylic acid functions (COOH) carried by the HASE copolymer are in the form of a salt, and more particularly in the form of sodium, potassium or ammonium salt.

Advantageously, the HASE copolymer comprises, notably consists of, relative to the total weight of the copolymer:
between 30% and 40% by weight of repetition units from methacrylic acid,
between 45% and 60% by weight of repetition units from ethyl acrylate, and
between 5% and 20% by weight of repetition units from a macromonomer of following chemical formula A:

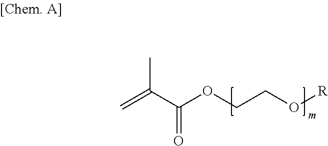

wherein:
   m is an integer greater than or equal to 5, preferably between 10 and 30, and
   R is a hydrocarbon group of formula CₙH₂ₙ₊₁, wherein n is an integer between 9 and 25, preferably between 10 and 22 and more preferably equal to 12.

The HASE copolymer may be prepared, for example, according to one of the methods described in WO2011/104599, WO2011/104600 and EP1778797. It may be Pharma 38 or Viscoatex 730LV from Coatex.

### Manufacturing Method

The microcapsules according to the invention can be prepared according to the method described above and, in particular, according to steps (a) to (e) when the outer shell comprises an HASE copolymer. The microcapsules are advantageously prepared in the form of an aqueous suspension.

### Step (a)

The fatty phases prepared in step (a) so as to obtain a mixture of wax, oil, pheromone (for example insect or mammal pheromone), carbon black particles, and one or more additives (preferably chosen among a carbon black particle dispersing additive, preferably non-ionic, an anti-UV additive, an antioxidant and a mixture thereof) having the composition of the core described above.

The fatty phase is kept, preferably under stirring, at a temperature greater than the melting temperature of the wax, so as to be liquid. In a particular embodiment, the fatty phase is at a temperature of 50° C. to 85° C., notably 60° C. to 80° C.

Advantageously, the fatty phase is prepared by mixing the oil and the additive or additives (in particular the preferably non-ionic, carbon black particle dispersing additive) which is heated to a temperature greater than the melting temperature of the wax, then adding the wax, then adding carbon black particles and the pheromone.

### Step (b)

The aqueous solution of step (b) can be prepared by basifying an aqueous solution comprising the HASE copolymer by adding a base, so as to obtain a pH greater than or equal to 7.6 (for example 7.6 to 10), notably greater than or equal to 8, in particular from 8 to 10. This base will advantageously be chosen from sodium or potassium carbonate, aluminium or ammonium or hydroxide or ammonia in aqueous solution, sodium hydroxide, potassium hydroxide and the combinations thereof.

Advantageously, the aqueous solution comprises 0.1% to 10%, in particular 0.1% to 5%, preferably 0.1% to 1%, by weight, HASE copolymer relative to the weight of the aqueous solution. The concentration of HASE copolymer in the aqueous solution makes it possible to influence the size of the final microcapsules. More specifically, the size of the final microcapsules is reduced when the concentration of HASE copolymer increases.

This aqueous solution is then heated to a temperature substantially identical to that of the fatty phase.

Advantageously, “temperature substantially identical” to that of the fatty phase shall mean a temperature not varying by more than 10° C., notably more than 5° C., relative to the temperature of step (a). Preferably, the temperature of step (b) will be identical to that of step (a).

Hence, the aqueous solution is advantageously at a temperature of 50° C. to 85° C., notably 60° C. to 80° C.

### Step (c)

In this step, the fatty phase having the temperature of step (a) is added to the aqueous solution having the temperature of step (b).

The mixture is then stirred so as to form a dispersion of fatty phase droplets in the aqueous solution. The droplets of fatty phase formed in the aqueous solution will form the core of the microcapsules.

### Step (d)

The acidification makes it possible to precipitate the HASE copolymer present in the aqueous solution on the droplets which then become microcapsules comprising the core based on the fatty phase surrounded by the solid shell based on the HASE copolymer. These particles are dispersed in water and then form an aqueous suspension of microcapsules.

In a particular embodiment, the acidification is carried out by adding an acid such as hydrochloric acid, phosphoric acid, sulfuric acid, an organic acid of the carboxylic acid type (in particular acetic acid or propionic acid) or a mixture of these, notably phosphoric acid, until reaching a pH of 6 to 7.5, preferably 6.5 to 7.2. This acid is preferably added in the form of an aqueous solution.

The temperature of the aqueous suspension of microcapsules thus obtained is then advantageously taken to a temperature less than the melting point of the wax, notably to a temperature between 20° C. and 30° C.

According to a particular embodiment, the method implements the steps below.
First step (step (a)): In a mixer provided with a heating system and mechanical stirring, the oil and the one or more additives, such as the preferably non-ionic, carbon black particle dispersing additive, are mixed and taken to a temperature greater than the melting temperature of the wax, then the wax is added. The mixture is homogenised before adding the carbon black particles and the pheromone. This phase represents a quantity Q expressed in kilograms
Second step (step (b)): In a reactor provided with a high-shear stirrer, water, preferably in a quantity Q, and HASE copolymer, preferably at a level of 0.1% to 10% wt/wt, notably 0.1% to 5% wt/wt, preferably from 0.1% to 1% wt/wt, are mixed, then the pH is taken to a value greater than or equal to 8, notably 8 to 10, by means of a basic solution, preferably at a concentration 5% to 10% wt/wt, of sodium hydroxide, potassium hydroxide or ammonia. When the solution is clear, the temperature is taken to the temperature of the mixture from the first step.
Third step (step (c)): The mixture of the first step (fatty phase) is added under stirring to the aqueous phase so as to form droplets. When the addition is completed, the stirring can be continued, notably for between 10 minutes and 2 hours.
Fourth step (step (d)): The pH is taken to a value of 6 to 7.5, preferably 6.5 to 7.2, by means of an acid solution, such as phosphoric acid, sulfuric acid or hydrochloric acid, notably at a concentration of 2 to 10% by weight. Acidification enables the coalescence of the HASE copolymer at the surface of the droplets, thus forming the solid shell around the cores of the microcapsules. The resulting aqueous suspension of microcapsules is then taken to ambient temperature, optionally under stirring.

### Use

The present invention also relates to the use of microcapsules according to the invention for protection, against insects or mammals, of a plant (in particular a cultivation) or a crop, in particular when said plant or crop is exposed to light, for example sunlight or artificial light.

The pheromones will influence the behaviour of animals such as insects (e.g. lepidoptera or aphids), rodents, or even game (e.g. roe deer, deer, fallow deer, wild boar) responsible for damage to plants (in particular cultivations) and crops. The pheromone or pheromones are chosen according to the animal (e.g. the insect or mammal) against which it is desired to protect the plant or crop. For example, the pheromone can be chosen in order to lure a lepidoptera in accordance with a trapping protocol or according to a sexual confusion protocol.

The microcapsules according to the invention, more particularly in the form of an aqueous suspension, can be applied by technical means known to a person skilled in the art, on supports present in the storage location (walls, posts, floors, etc.) or on sacks containing grains.

In the case of plant protection, the microcapsules, notably in the form of an aqueous suspension, can more particularly be applied on plants, notably on their leaves, for example by means of a spray system.

The plants to be protected will advantageously be cultivations. These cultivations may be in the form, for example, of a covered plot (e.g. greenhouse, nursery) or an open plot (e.g. fields, forests).

The plants to be protected are preferably vines, field crops (rice, corn, cotton, soya, sunflower, etc.), market garden crops (tomatoes, lettuces, peppers, melons, cucumbers, cabbages, spinach, etc.), trees (e.g. fruit or ornamental trees (apple, peach, pear, citrus, almond, etc.), forests (pine forests, oak forests, etc.)), or shrubs (boxwood, etc.).

The crops to be protected will particularly be grains such as wheat or corn, etc. It involves protecting these grains during storage.

### FIGURES

FIG. 1: photograph by optical obtained microscopy of the microcapsules obtained in example 1.

FIG. 2: monitoring the release over time of pheromone (I) encapsulated in microcapsules with carbon black particles, placed in an oven at 30° C.

FIG. 3: monitoring of the isomerisation over time of the pheromone of formula (I) encapsulated in microcapsules with or without carbon black particles and subject to light radiation (daylight).

FIG. 4: size distribution curve for the microcapsules of examples 2a and 2b.

FIG. 5: photograph obtained by optical microscopy of the microcapsules obtained in example 3.

FIG. 6: photograph of the test tubes of examples 4a (tube a), 4b (tube b) and 4c (tube c) obtained after 5 minutes under ultrasound.

FIG. 7: photograph of the suspension of microcapsules from counter-example 5.

FIG. 8: particle size curve of microcapsules from counter-example 7.

### EXAMPLES

The pheromones used in the examples were produced by the applicant according to the methods known to a person skilled in the art. The HASE copolymers used, namely Pharma 38 and Viscoatex 730VL, were supplied commercially by Coatex. The carbon black particles used in the examples are synthetic carbon black particles obtained from acetylene and composed of primary particles having a median diameter D50 of 14 to 20 nm, but the aggregates of which have a size of order 100 micrometres.
The size of the microcapsules is measured by light diffraction analysis using a Mastersizer 3000 instrument by laser beam diffraction. The measurement protocol is as follows:

First, the samples are prepared by dispensing 0.5 g of formulation in 100 ml of demineralised water under magnetic stirring for 10 minutes. Then the particle size measurement is performed taking care first to align the instrument and to measure the background noise in order to record the diffraction phenomena caused by the water. The sample is then introduced into the measurement cell and 5 successive measurements are performed. These measurements enable a size distribution curve to be established, from which the median diameter D50 is determined. The particle size is then determined by taking the average of these 5 measurements.
The analysis of the contents of pheromone is carried out by gas chromatography (GC) using a flame ionisation detector on an Agilent-HP series II 5890 instrument.
The pheromone release studies are carried out in ventilated ovens without windows, so as not to be exposed to light radiation. These studies were carried out according to two methods, either by monitoring weight loss of the samples or by monitoring the residual concentration of the pheromone in the samples, by GC.
The studies of accelerated ageing under light, in order to study photochemical degradation (for example an isomerisation) are carried out in daylight or in the laboratory by means of a table solar simulator, the Solartest 1200.
Optical microscopy is carried out on an AXIO PLAN 2 microscope from ZEISS. The observations of samples are carried out in transmission with a 40× plan and 20× plan objective lens. An AxioCam ICC3 camera from ZEISS enables images to be displayed on a computer screen.

For Example 8b, the pheromone mixture of Grapholita molesta was used. This mixture is composed of two molecules (VIII) and (IX) in a ratio 15/85:

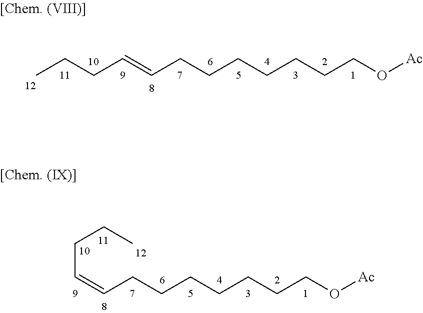 [SMILES: CCC/C=C/CCCCCCCOC(C)=O ; CCC/C=C\CCCCCCCOC(C)=O]

### Example 1: Microcapsules with Pheromone (I)

In a 500-mL jacketed glass reactor, provided with mechanical stirring, 200 g of sunflower oil are introduced, then 2 g of Disperbyk® 163 (additive that disperses carbon black particles). The mixture is taken to a temperature of 80° C., then 90 g of purified beeswax are added. Once returned to 80° C., 2 g of Emperor® 1200 carbon black particles are added. After several seconds, the mixture becomes uniformly black and 15 g of pheromone (I) are then added. The core formulation is left under stirring during the preparation of the shell formulation.

In a 1-L jacketed reactor, equipped with a magnetic stirrer, 307 mL of deionised water are added, then 9.6 g of Viscoatex 730LV (i.e. 3.2 g of dry matter). A 10% sodium hydroxide solution is then poured, drop by drop, so as to reach a pH of 8.5. This corresponds to a mass of 5.2 g of sodium hydroxide solution under stirring. The formulation becomes thick and translucent with bluish reflections. The temperature of the solution is then taken to 80° C.

Using a peristaltic pump, the core formulation is transferred into the 1-L reactor at a flow rate of 5 mL per minute. In order not to freeze the oily phase in the transfer tubes, these are immersed in a water bath at 80° C.

The viscosity of the medium increases gradually. At the end of the addition, the stirring is continued for an additional hour while stopping the heating. When the temperature reaches 60° C., 11 mL of a 4% by weight phosphoric acid solution is added under strong stirring. The formulation becomes fluid and reaches a pH of 6.7. Once the assembly has returned to ambient temperature, a suspension of grey microcapsules is recovered.

### Characteristics Obtained:

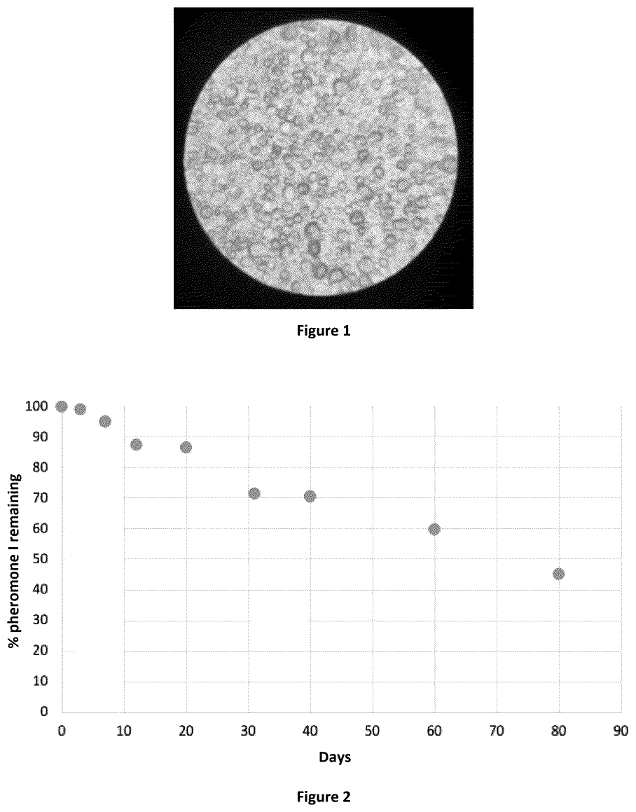

Dry extract: 48%
Degree of encapsulation T: 99.7%
T=(total quantity of (I)−quantity of (I) in the water)/total quantity of (I)
Median diameter D50: 7 μm−Monomodal dispersion (no traces of carbon black agglomerates)
Characterisation by microscopy: see photograph in FIG. 1.

This photograph shows that the carbon black particles are inside the microcapsules.
Release of the pheromone in an oven at 30° C.:

2 g of the suspension of microcapsules are deposited in plastic cups and placed in an oven. TO for the study is 24 hours after this placing in the oven. One cup is then analysed regularly by measuring its weight and by GC in order to estimate the release of the pheromone under these conditions. For a study over 80 days, a cup is sampled at D3, D7, D12, D20, D31, D40, D60 and D80.

The results obtained are presented in FIG. 2. A controlled release is observed over several weeks. Hence, the presence of carbon black particles in the microcapsules in no way interferes with the encapsulation and the prolonged release of the pheromone.
Monitoring the isomeric ratio over time:

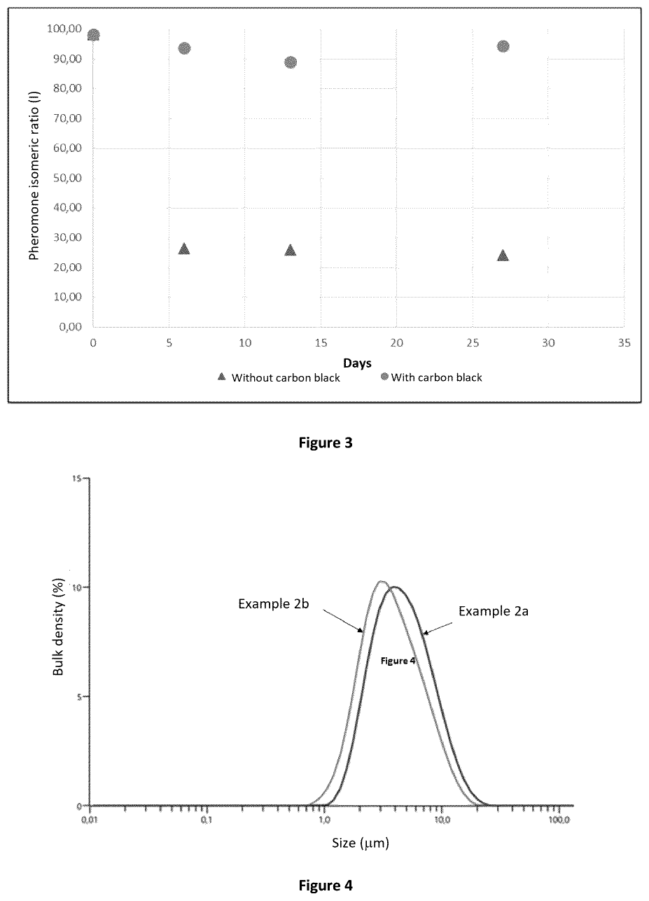

The results obtained are presented in FIG. 3. The measurements show that the isomerisation of the pheromone (I) is less rapid for the formulation with carbon black particles than for the control corresponding to the same formulation but without carbon black particles. This shows the improved stability of the pheromones in the microcapsules according to the invention.

### Example 2: Microcapsules with Pheromone (I)

In a 250-mL glass, jacketed reactor, equipped with an Ultra-Turrax™ T18 homogeniser, 45.5 g of sunflower oil are introduced, followed by 0.08 g of Emperor® 1200 (example 2a) or Emperor® 1600 (example 2b) carbon black. The mixture is stirred vigorously at 14,000 rpm for 1 hour in order to thoroughly disperse the carbon black particles in the oil.

This mixture is then taken to a temperature of 80° C., then 18.6 g of purified beeswax, 1.7 g of BHT and 0.7 g of oxybenzone are added. Once the mixture has returned to 80° C., 6.8 g of pheromone (I) are then added. The core formulation is left under stirring during the preparation of the shell formulation.

In a 500-mL jacketed reactor, equipped with an IKA magnetic stirrer controlled at 350 rpm, 158 mL of deionised water are added, then 8.8 g of Pharma 38 (i.e. 2.6 g of dry matter). A 10% sodium hydroxide solution is then poured, drop by drop, so as to reach a pH of 10. This corresponds to a mass of 4.9 g of sodium hydroxide solution under stirring. The formulation becomes thick and translucent with bluish reflections. The temperature of the solution is then taken to 80° C.

Using a peristaltic pump, the core formulation is transferred into the 1 L reactor at a flow rate of 5 mL per minute. In order not to freeze the oily phase in the transfer tubes, these are immersed in a water bath at 80° C.

The viscosity of the medium increases gradually. At the end of the addition, the stirring is continued for an additional hour. Then, 4.5 g of a 4% by weight phosphoric acid solution is added under strong stirring. The formulation becomes fluid and reaches a pH of 6.8. The medium is left to naturally return to ambient temperature. Then, a suspension of grey microcapsules is recovered. The features of the microcapsules thus obtained are presented in Table 2 below. In addition, the size distribution curve for the microcapsules is shown in FIG. 4.

TABLE 2

| Characteristics obtained | Example 2a | | Example 2b | |
|---|---|---|---|---|
| Dry extract | 31% | | 31% | |
| Total pheromone dose | 2.44% | by weight | 2.39% | by weight |
| Freely dosed pheromone | 0.007% | | 0.004% | |
| Encapsulation yield | 99.75% | | 99.84% | |
| Median diameter of | 4.41 | μm | 3.56 | μm |
| microcapsules | | | | |

| | | |
|---|---|---|
| Type of particle distribution | Monomodal | Monomodal |

### Example 3: Microcapsules of Pheromone VI

In a melter equipped with a turbine-type stirrer, 2.24 kg kilograms of sunflower oil are introduced followed by 3.6 g of carbon black. The mixture is stirred vigorously at 150 rpm for 40 minutes in order to thoroughly disperse the carbon black particles in the oil.

This mixture is then taken to a temperature of 80° C., then 900 g of purified beeswax, 85 g of BHT and 52 g of Tinuvin® 571 are added. Once returned to 80° C., 127 g of pheromone (VI) are then added. The core formulation is left under stirring during the preparation of the shell formulation.

In a 15-L unit equipped with a fixed speed blade-and-scraper stirrer and a variable speed homogeniser, 8.29 kg of deionised water are added, then 110 g of Viscoatex 730LV (i.e. 33 g of dry matter). A 10% sodium hydroxide solution is then poured, drop by drop, so as to reach a pH of 10. This corresponds to a mass of 69 g of sodium hydroxide solution under stirring. The formulation becomes thick and translucent with bluish reflections. The temperature of the solution is then taken to 80° C.

Using a peristaltic pump, the core formulation is transferred into the 15-L reactor (homogeniser controlled at 4000 rpm) at a flow rate of 50 kg/h. The viscosity of the medium increases gradually. At the end of the addition, the stirring is continued for an additional 20 minutes. Maintaining a speed of 4000 rpm, 123 g of a 4% by weight phosphoric acid solution is then added. The formulation becomes fluid and reaches a pH of 6.7. After 25 minutes stirring at 4000 rpm, a grey suspension of microcapsules is recovered.

### Characteristics Obtained:

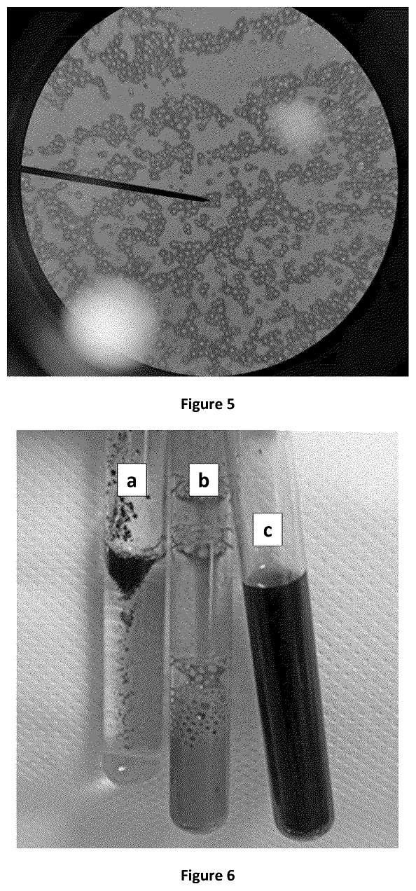

Median diameter D50=4.63 μm−Monomodal distribution.
Encapsulation yield=100%
Characterisation by microscopy; see photograph in FIG. 5.

The photograph in FIG. 5 shows that the carbon black particles are inside the microcapsules, and, more particularly, at the periphery of the microcapsules, which suggests that the HASE copolymer shell (Viscoatex 730LV) plays an important role in the incorporation of the elementary particles of carbon black in the pheromone microcapsules.

### Example 4 (not According to the Invention): Importance of the Oil and HASE Copolymer for Dispersing the Carbon Black Particles

Carbon black dispersion tests were carried out in water, in a 30% by weight aqueous solution of Pharma 38 and in oil.

Carbon black was loaded into a test tube and then the dispersion medium was studied. The assembly was placed under ultrasound for 5 minutes. The tests performed are presented in Table 3 below.

TABLE 3

| Ingredient (in g) | Example 4a | | Example 4b | | Example 4c | |
|---|---|---|---|---|---|---|
| Nature of the | Water | | 30% Pharma | | Sunflower oil | |
| dispersion medium | | | 38 in water | | | |
| Dispersion medium | 5.0 | g | 5.0 | g | 4.5 | g |
| Carbon black | 0.005 | g | 0.005 | g | 0.005 | g |

An observation of the obtained suspension is then performed (cf. FIG. 6). The following results were obtained, showing:
example 4a: a very poor dispersion of carbon black is observed in water. The carbon black particles immediately rise back to the surface leaving the aqueous phase perfectly transparent;
example 4b: a good dispersion of carbon black is observed in the Pharma 38 solution. The carbon black particles remain well suspended in the medium after resting for 18 hours;
example 4c: a good dispersion of carbon black is observed in sunflower oil. The suspension of carbon black does not change after 18 hours without stirring.

This example, which is not according to the invention, shows that the use of HASE copolymer and oil contributes to the homogeneous distribution of the carbon black and influences the obtaining of a monomodal distribution of microcapsules according to the invention.

In addition, the fact that FIG. 5 shows a distribution of the carbon black at the surface of the microcapsules demonstrates the preponderant role of the HASE copolymer which constitutes the shell of the microcapsules.

### Example 5 (Counter-Example, not According to the Invention): Microcapsules of Pheromone I Containing Vegetable Carbon Black

The microcapsules of this example were prepared according to the procedure described in example 2, replacing the Emperor® 1200 or 1600 carbon black by vegetable carbon black which does not aggregate but for which the primary particle sizes are greater than 10 micrometres.

### Results:

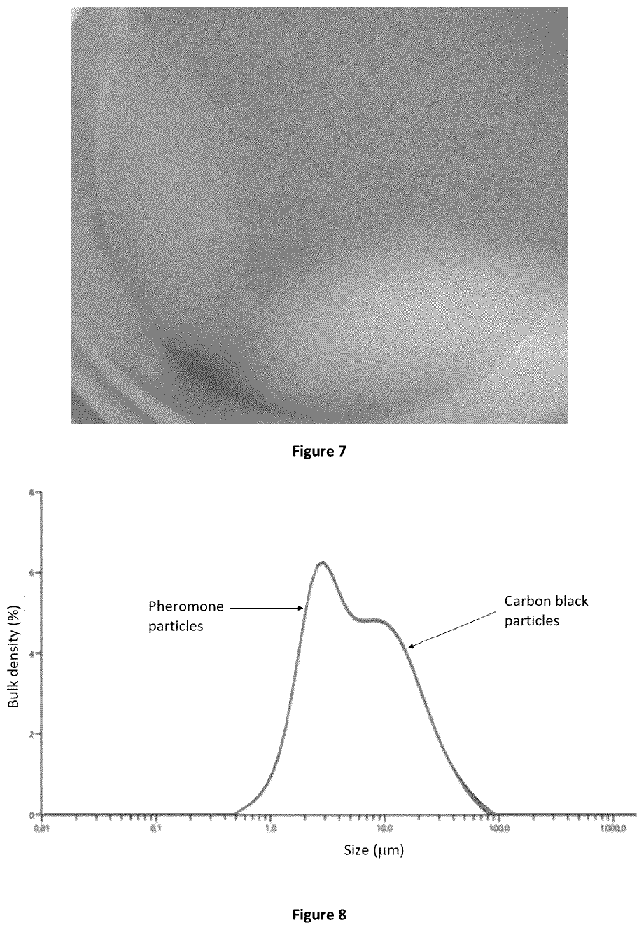

The appearance of the suspension of microcapsules is white with black specks visible to the naked eye (FIG. 7). The size distribution curve of the microcapsules is presented in FIG. 8 and shows a bimodal size distribution profile.

The size distribution profile for these microcapsules shows that, during the manufacturing process of the microcapsules, the particles of vegetable carbon black have not been reduced in size by the process, which prevents their incorporation in the microcapsules, resulting in the obtaining of two types of particles. The size distribution profile of such a suspension of microcapsules prevents its use by spraying. In addition, the segregation of the carbon black particles suggests that it will not be able to provide its protective role for the pheromone present in the microcapsule.

In particular, this counter-example illustrates that the choice of carbon black particles having primary particle sizes that are too large does not allow homogeneous dispersion to be obtained.

### Example 6 (Counter-Example, not According to the Invention): Test of the Formation of Microcapsules of Pheromone VI by Introducing Carbon Black in Step b)

The microcapsules of this example have been prepared according to the procedure described in example 1, using the ingredients mentioned in Table 4 below and by introducing carbon black in the aqueous phase containing the HASE copolymer.

TABLE 4

| Part of the microcapsule | Ingredient | Weight in g |
|---|---|---|
| Core formulation | Pheromone (VI) | 3.00 |
| | Sunflower oil | 64.8 |
| | Carbon black | 0.64 |
| | BHT (antioxidant) | 1.9 |
| Shell formulation | Demineralised water | 155.6 |
| | Viscoatex 730LV | 1.5 |
| | (in g of dry matter) | |
| | 10% sodium hydroxide | 3.4 |
| | 4% H₃PO₄ | 4.2 |

In this test, the formulation has separated during the acidification phase. This counter-example shows the importance of the order in which the materials are introduced, in order to ensure good stability of the microcapsules of pheromone and carbon black. This counter-example also shows that the method according to the invention is essential for obtaining a stable, homogeneous and monomodal dispersion of particles of pheromones and carbon black.

### Example 7: Microcapsules with Pheromone (VI) and Different Contents of Carbon Black Particles

The microcapsules of this example have been prepared according to the procedure described in example 1, using the ingredients mentioned in Table 5 below (the one or more additives being added just after the oil).

TABLE 5

| | | Exam- | Exam- | Exam- |
|---|---|---|---|---|
| Part of the | | ple 7a | ple 7b | ple 7c |
| microcapsule | Ingredient | Weight in g | | |
| Core | Pheromone (VI) | 3.00 | 3.03 | 2.95 |
| formulation | Sunflower oil | 64.83 | 65.13 | 65.33 |
| | Beeswax | 0.65 | 0.63 | 0.68 |
| | Emperor ® 1600 | 0.63 | 0.33 | 0.15 |
| | (carbon black) | | | |
| | BHT (antioxidant) | 1.902 | 1.80 | 1.91 |
| Shell | Demineralised water | 166.86 | 167.86 | 167.83 |
| formulation | Viscoatex 730LV | 1.5 | 1.5 | 1.5 |
| | (in g of dry matter) | | | |
| | 10% sodium hydroxide | 2.73 | 2.73 | 2.73 |
| | 4% H₃PO₄ | 4.53 | 3.65 | 3.58 |

| | | | |
|---|---|---|---|
| Content of carbon black relative | 0.9% | 0.465% | 0.2% |
| to the core formulation | | | |

Error! Not a valid link. The encapsulation yields obtained with the three formulations 7a to 7c are presented in Table 6 below. They show that the presence of carbon black particles in the microcapsule, whatever their percentage, does not alter the encapsulation of the pheromone in the microcapsules.

TABLE 6

| | Example 7a | Example 7b | Example 7c |
|---|---|---|---|
| Total dosage of the | 1.19% | 1.26% | 1.19% |
| active substance | | | |
| Dosage of the free | 0.01% | 0.003% | 0.012% |
| active substance | | | |
| Encapsulation yield | 99.19% | 99.33% | 98.94% |

### Example 8: Microcapsules with Different Pheromones and Different Formulations

The microcapsules of this example have been prepared according to the procedure described in example 1, using the ingredients mentioned in Table 7 below (the one or more additives being added just after the oil).

TABLE 7

| | | Exam- | Exam- | Exam- | Exam- |
|---|---|---|---|---|---|
| Part of the | | ple 8a | ple 8b | ple 8c | ple 8d |
| microcapsule | Ingredient | Weight in g | | | |
| Core | Pheromone | 130.2 | 36.6 | 57.3 | 5.5 |
| formulation | Sunflower oil | 350.6 | 230.0 | 378.0 | 120 |
| | Beeswax | 3.5 | 94.0 | 155.3 | 1.2 |
| | Emperor ® 1600 | 0.45 | 0.4 | 0.6 | 0.6 |
| | (carbon black) | | | | |
| | Oxybenzone | 11.9 | — | 8.9 | 0.7 |
| | (anti-UV additive) | | | | |
| | BHT (antioxidant) | 11.8 | 8.5 | 15.2 | 3.5 |
| Shell | Demineralised water | 500 | 800.0 | 1250.0 | 300.0 |
| formulation | Pharma 38 | 17.6 | 13.2 | 23.5 | 4.9 |
| | (in g of dry matter) | | | | |
| | 10% sodium | 30.5 | 23.6 | 41.7 | 8.8 |
| | hydroxide | | | | |
| | 4% H₃PO₄ | 1.9 | 17.6 | 47.8 | 10.5 |

| | | | | |
|---|---|---|---|---|
| Nature of the pheromone | (II) | (VIII)/ | (I) | (VI) |
| | | (IX) | | |

The encapsulation yields obtained with the four formulations 8a to 8d are presented in Table 8 below. These yields are very good whatever the formulation.

TABLE 8

| | Exam- | Exam- | Exam- | Exam- |
|---|---|---|---|---|
| | ple 8a | ple 8b | ple 8c | ple 8d |
| Total dosage of the | 12.3% | 2.46% | 2.7% | 1.15% |
| active substance | | | | |
| Dosage of the free | 0.45% | 0.008% | 0.01% | 0.019% |
| active substance | | | | |
| Encapsulation yield | 97.6% | 99.4% | 99.63% | 98.3% |

### Example 9: Microcapsules of Pheromone (VI) with Different Encapsulating Polymers

The microcapsules of this example have been prepared according to the procedure described in example 1, using the ingredients mentioned in Table 9 below (the one or more additives being added just after the oil).

TABLE 9

| Part of the | | Example 9a | Example 9b |
|---|---|---|---|
| microcapsule | Ingredient | Weight in g | |
| Core | Pheromone (VI) | 10.8 | 10.5 |
| formulation | Sunflower oil | 231.8 | 231.7 |
| | Beeswax | 23 | 23 |
| | Emperor ® 1600 | 1.16 | 1.16 |
| | (carbon black) | | |
| | BHT (antioxidant) | 6.4 | 6.8 |
| Shell | Demineralised water | 600 | 572 |
| formulation | Viscoatex 730LV | 5.34 | — |
| | (in g of dry matter) | | |
| | Pharma 38 | — | 9.4 |
| | (in g of dry matter) | | |
| | 10% sodium hydroxide | 9.7 | 16.8 |
| | 4% H₃PO₄ | 13 | 19.85 |

This example shows that different HASE copolymers can be used for manufacturing pheromone microcapsules according to the invention comprising carbon black particles.

### Example 10: Effect of Carbon Black Particles on the Protection of Pheromones

Microcapsules based on pheromone (VI) and various anti-UV additive additives instead of and in place of carbon black particles have been prepared according to the method of example 1, using the ingredients mentioned in Table 10 below (the one or more additives being added just after the oil).

TABLE 10

| | | Ex. | Ex. | Ex. | Ex. |
|---|---|---|---|---|---|
| Part of the | | 10a* | 10b | 10c* | 10d* |
| microcapsule | Ingredient | Weight in g | | | |
| Core | Pheromone (VI) | 2.97 | 3.08 | 3.00 | 3.03 |
| formulation | Sunflower oil | 45.71 | 48.40 | 45.70 | 46.30 |
| | Beeswax | 18.60 | 19.38 | 18.60 | 18.60 |
| | anti-UV additive | 1.10 | 0.33 | 1.10 | 0.63 |
| | BHT | 1.80 | 1.88 | 1.90 | 1.90 |
| | (antioxidant) | | | | |
| Shell | Demineralised | 161.02 | 162.08 | 161.03 | 160.58 |
| formulation | water | | | | |
| | Pharma 38 | 2.67 | 2.78 | 2.67 | 2.64 |
| | (in g of dry | | | | |
| | matter) | | | | |
| | 10% sodium | 4.73 | 4.93 | 4.73 | 4.73 |
| | hydroxide | | | | |
| | 4% H₃PO₄ | 5.20 | 0.68 | 5.05 | 5.45 |

| | | | | |
|---|---|---|---|---|
| UV protection studied | Oxy- | Carbon | Tinuvin ® | TiO₂ |
| | benzone | black | 571 | |

*comparative examples

Pheromone (VI) is very fragile and rearranges itself very easily into isomer E, Z under the effect of visible light. After exposing the microcapsules of examples 10a to 10d to daylight on cardboard slabs, the change in concentration over time of various isomers remaining in the microcapsules is measured. The results obtained are presented in Table 11 below.

TABLE 11

| | Content of pheromone (VI) and its isomers in the | | | |
|---|---|---|---|---|
| | microcapsules (ratio of pheromone (VI)/isomers) | | | |
| | Example 10a | Example 10b | Example 10c | Example 10d |
| Day 0 | 100% (96/4) | | | |
| Day 5 | 92% | 97% | 95% | 95% |
| Day 10 | 85% | 95% | 90% | 88% |
| Day 15 | 79% | 92% | 84% | 83% |
| | (90.7/9.3) | (96/4) | (91.7/8.3) | (90.3/9.7) |

These results show a better stability (conservation of the initial isomeric ratio) of the studied active ingredient, namely pheromone (VI), in microcapsules according to the invention containing carbon black particles, compared with microcapsules containing anti-UV chemical additives such as oxybenzone, Tinuvin® 571 or TiO₂, and this for a level of additive in the microcapsules that is 2 to 4 times lower. This demonstrates that the microcapsules according to the invention release the pheromone only in the form of its effective active ingredient, in contrast to the other microcapsules.

### Example 11: Microcapsules of Pheromone (VI) with a Higher Content of Carbon Black Particles

The microcapsules of this example have been prepared according to the procedure described in example 1, using the ingredients mentioned in Table 12 below.

TABLE 12

| Part of the | | Example 11a | Example 11b |
|---|---|---|---|
| microcapsule | Ingredient | Weight in g | |
| Core | Pheromone (VI) | 12 | 24 |
| formulation | Sunflower oil | 240 | 240 |
| | Beeswax | 100 | 100 |
| | Emperor ® 1600 | 6 | 12 |
| | (carbon black) | | |
| | Disperbyk ® 163 | 6 | 12 |
| | (dispersant agent) | | |
| Shell | Demineralised water | 600 | 600 |
| formulation | Pharma 38 | 15 | 15 |
| | (in g of dry matter) | | |
| | 10% sodium hydroxide | 9.7 | 9.5 |
| | 4% H₃PO₄ | 13 | 12.8 |

| | | |
|---|---|---|
| Total pheromone content | 1.2% | 2.3% |
| Pheromone content in the cores | 3.3% | 6.2% |
| Content of carbon black | 1.6% | 3.1% |
| in the microcapsules | | |

### Example 12: Microcapsules with Low Concentrations of Pheromones (III), (IV) and (XI) in View of Diffusers for Trapping Tomato Leaf Miners, Horse-Chestnut Leaf Miners and Oak Processionals

The microcapsules of this example have been prepared according to the procedure described in example 1, using the ingredients mentioned in Table 13 below.

TABLE 13

| | | Exam- | Exam- | Exam- |
|---|---|---|---|---|
| Part of the | | ple 12a | ple 12b | ple 12c |
| microcapsule | Ingredient | Weight in g | | |
| Core | Pheromone | 1 g of III | 1 g of IV | 1 g of XI |
| formulation | Sunflower oil | 70 | 70 | 70 |
| | Beeswax | 30 | 30 | 30 |
| | Emperor ® 1600 | 0.2 | 0.2 | 0.2 |
| | (carbon black) | | | |
| | Disperbyk ® 163 | 0.2 | 0.2 | 0.2 |
| | (dispersant agent) | | | |
| Shell | Demineralised water | 100 | 100 | 100 |
| formulation | Pharma 38 | 3 | 3 | 3 |
| | (in g of dry matter) | | | |
| | 10% sodium hydroxide | 2.1 | 2.0 | 2.0 |
| | 4% H₃PO₄ | 0 | 0 | 0 |

| | | | |
|---|---|---|---|
| Nature of the pheromone | (III) | (IV) | (XI) |

These three formulations have an encapsulation rate greater than 99%.

### Example 13: Microcapsules of Pheromones (X) and (XII) in View of Diffusers for Combating Carob Moth

The microcapsules of this example have been prepared according to the procedure described in example 1, using the ingredients mentioned in Table 14 below.

TABLE 14

| Part of the | | Example 13a | Example 13b |
|---|---|---|---|
| microcapsule | Ingredient | Weight in g | |
| Core | Pheromone | 20.8 g of X | 20.8 g of XII |
| formulation | Sunflower oil | 106.4 | 106.4 |
| | Beeswax | 43.2 | 43.2 |
| | Tinuvin ® 571 | 2.1 | 2.1 |
| | BHT | 4.1 | 4.1 |
| | Emperor ® 1600 | 0.9 | 0.9 |
| | (carbon black) | | |
| | Disperbyk ® 163 | 0.9 | 0.9 |
| | (dispersant agent) | | |
| Shell | Demineralised water | 100 | 100 |
| formulation | Pharma 38 | 6.1 | 6.1 |
| | (in g of dry matter) | | |
| | 10% sodium hydroxide | 11.0 | 11.0 |
| | 4% H₃PO₄ | 8.4 | 8.4 |

| | | |
|---|---|---|
| Nature of the pheromone | (X) | (XII) |

These two formulations have an encapsulation rate greater than 99%.

1. Microcapsules having a median diameter D50 ranging from 0.5 μm to 20 μm comprising:
a core comprising a mixture of wax, oil, pheromone and carbon black particles, the carbon black particles being composed of primary particles having a median diameter D50 ranging from 10 nm to 50 nm, and
a solid outer shell surrounding the core, the shell comprising an HASE copolymer, optionally totally or partially neutralised, in the form of a sodium, potassium or ammonium salt.

2. The microcapsules according to claim 1, wherein the carbon black particles consist of primary particles having a median diameter D50 ranging from 10 nm to 40 nm.

3. The microcapsules according to claim 1, wherein the pheromone carries a photosensitive function.

4. The microcapsules according to claim 1, wherein the pheromone is an insect pheromone, a mammal pheromone or an analogue thereof.

5. The microcapsules according to claim 1, wherein the pheromone is chosen among the following molecules (I) to (XII) and the mixtures thereof:

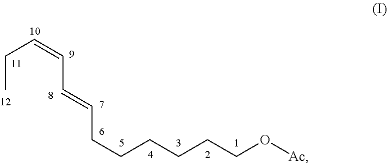 [SMILES: CC/C=C\C=C\CCCCCCOC(C)=O]

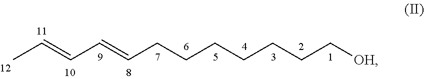

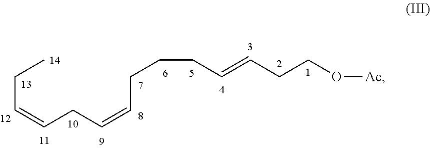 [SMILES: CC/C=C\C/C=C\CCC/C=C/CCOC(C)=O]

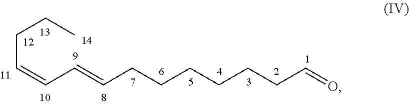

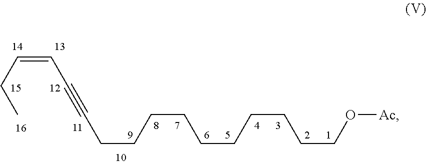 [SMILES: CC/C=C\C#CCCCCCCCCCCOC(C)=O]

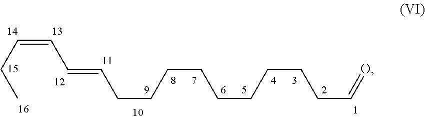 [SMILES: CC/C=C\C=C\CCCCCCCCCC=O]

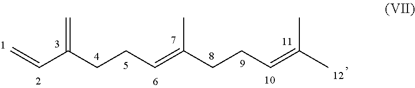

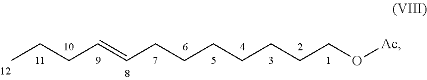 [SMILES: CCC/C=C/CCCCCCCOC(C)=O]

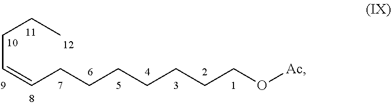 [SMILES: CCC/C=C\CCCCCCCOC(C)=O]

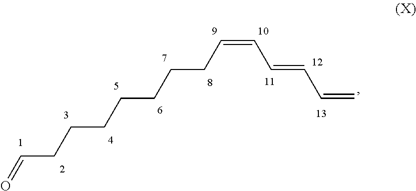

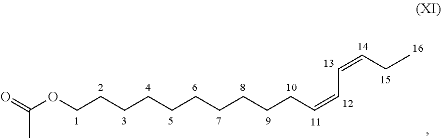 [SMILES: CC/C=C\C=C/CCCCCCCCCCOC(C)=O]

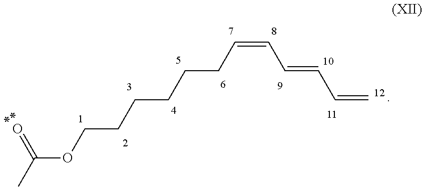 [SMILES: C=C/C=C/C=C\CCCCCCOC(C)=O]

6. The microcapsules according to claim 1, wherein the core represents 90% to 99.9% by weight of the weight of the microcapsules.

7. The microcapsules according to claim 1, wherein the core contains, relative to the weight of the core:
0.5% to 30%, by weight, of pheromone,
0.01% to 10% by weight, of carbon black particles,
0.5% to 50% by weight, of wax, and
20% to 95% by weight, of oil.

8. The microcapsules according to claim 1, wherein the core further contains a carbon black particle dispersing additive.

9. The microcapsules according to claim 8, wherein the core contains up to 10% by weight, of carbon black particle dispersing additive relative to the weight of the core.

10. The microcapsules according to claim 8, wherein the carbon black particle dispersing additive is present in the core in a quantity, by weight, that is less than or equal to that of the carbon black particles.

11. The microcapsules according to claim 1, wherein the core further contains an anti-UV additive, an antioxidant or a mixture thereof.

12. (canceled)

13. A method for manufacturing microcapsules according to claim 1, comprising:
(a) preparing a fatty phase comprising wax, oil, pheromone and carbon black particles, and optionally one or more additives when they are present, the fatty phase having a temperature greater than the melting temperature of the wax,
(b) preparing an aqueous solution comprising 0.1% to 10% by weight of the HASE copolymer relative to the weight of the aqueous solution, the aqueous solution having a pH greater than or equal to 7.6 and a temperature substantially identical to that of the fatty phase,
(c) adding the fatty phase to the aqueous solution and stirring so as to form a dispersion of fatty phase droplets in the aqueous solution, and
(d) acidifying the dispersion to a pH of 6 to 7.5.

14. The method according to claim 13, wherein the temperature at step (a) and at step (b) ranges from 50° C. to 85° C.

15. The method according to claim 13, wherein the aqueous solution prepared in step (b) comprises 0.1% to 5%, by weight, HASE copolymer relative to the weight of the aqueous solution.

16. The microcapsules according to claim 1, wherein the median diameter D50 of the microcapsules ranges from 1 μm to 10 μm.

17. The microcapsules according to claim 1, wherein the carbon black particles consist of primary particles having a median diameter D50 ranging from 11 nm to 30 nm.

18. The microcapsules according to claim 1, wherein the pheromone is a lepidoptera pheromone, an aphid pheromone, an analogue thereof or a mixture thereof.

19. The microcapsules according to claim 1, wherein the core contains, relative to the weight of the core:
1% to 15% by weight, of pheromone,
0.1% to 5% by weight, of carbon black particles,
1% to 25% by weight of wax, and
30% to 90% by weight, of oil.

20. A method for protecting a plant or a crop against insects or mammals comprising a step of applying microcapsules on the plant or the crop, the microcapsules having a median diameter D50 ranging from 0.5 μm to 20 μm comprising:
a core comprising a mixture of wax, oil, pheromone and carbon black particles, the carbon black particles being composed of primary particles having a median diameter D50 ranging from 10 nm to 50 nm, and
a solid outer shell surrounding the core, the shell comprising an HASE copolymer, optionally totally or partially neutralised, in the form of a sodium, potassium or ammonium salt.

21. The method of claim 20, wherein the plant or the crop is exposed to light.
